(19) United States
(12) Patent Application Publication
(10) Pub. No.: US 2006/0149870 A1
(43) Pub. Date: Jul. 6, 2006

(54) Parallel to USB bridge controller

(76) Inventors: Randall Sears, Cedar Park, TX (US); David M. Mervine, Rowlett, TX (US); Paul Highley, Austin, TX (US)

Correspondence Address: HOWISON & ARNOTT, L.L.P, P.O. BOX 741715, DALLAS, TX, 75374-1715, US

(21) Appl. No.: 11/026,989

(22) Filed: Dec. 30, 2004

(51) Int. Cl. G06F 13/38

(52) U.S. Cl. 710/71

(57) ABSTRACT

A parallel to USB bridge controller includes a USB transceiver for transmitting and receiving on a USB link and a serial interface engine connected to the USB link for converting between USB protocol and serial interface protocol. A memory interface within the controller includes a transmit data register for receiving data from a parallel data link and a receive register for receiving data to be transmitted over the parallel data link. The transmit data register and the receive data register of the memory interface are located within the memory space of a processor connected to the USB serial interface. The memory interface is able to send and receive data between the transmit and receive data registers and an external processor over the parallel data link.

### REFERENCE TO RELATED APPLICATION

This application is related to U.S. patent application Ser. No. 10/625,580, filed Jul. 23, 2003.

### TECHNICAL FIELD OF THE INVENTION

The present invention pertains to a universal serial bus (USB) serial data interface, and more particularly, to a parallel to USB bridge controller for interconnecting a microcontroller in a peripheral device to a host USB device.

### BACKGROUND OF THE INVENTION

The serial data bus has seen widespread and ever increasing acceptance and use in the PC industry as compared to the parallel data bus. In early computers, although there was provided both a serial data interface and a parallel data interface, the parallel data interface was preferred over the serial data interface due primarily to the speed difference, this due to the fact that the data is transferred in a parallel manner. However, this parallel interface required more wires, a bulkier connector and cable, etc., whereas the serial data interface required smaller connectors and smaller cables. However, of course, the serial data interface transfers only a single bit of data at a time. Therefore, it is inherently slower. To increase the speed of the serial data interface, various serial data protocols were examined. One of these was the “fire wire” configuration, and one was the universal serial bus (USB) configuration. Although fire wire was considered to be far superior to USB, the USB interface became more popular. One of the reasons for this is the fact that it actually provides power to the peripheral device. Initially, this was not an advantage but, with later advances in such things as flash memory and low power peripheral devices, the delivery of power to a peripheral device through a serial data interface became more practical. The USB interface provided this capability with up to 500 milliamps of current being made available, this providing both power in association with a serial data interface, which opened up a number of avenues for many peripheral devices. All that was required to interface with most peripheral devices in the computer was to have a USB interface.

However, in order to interface the USB port on various peripheral devices with a mother board, for example, there is required some type of processing to convert the data between the serial data interface protocol and data bus format on the mother board. The data transfer is typically what is referred to as “asynchronous” such that some type of clock synchronization is required to extract the data from the received data stream and determine the relationship between the timing of the received data stream and determine the relationship between the timing of the receive data and the timing of the mother board data, an APC for example.

Existing connections of microcontroller units in a peripheral device to a universal serial bus host require the connecting peripheral device to provide a great deal of code in order to enable the transmission from the microcontroller of the peripheral device to the universal serial bus host over the USB connection. Thus, rather than providing a parallel output as normally configured to do, the microcontroller unit within the connected peripheral device must include additional coding to enable universal serial bus communications. Some manner for enabling the peripheral device containing the microcontroller unit to continue to communicate with a parallel interface rather than a USB interface would greatly simplify the manufacture of such devices and facilitate USB communication.

### SUMMARY OF THE INVENTION

The present invention disclosed and claimed herein, in one aspect thereof, comprises a parallel to serial bridge controller. The parallel to serial bridge controller includes a USB transceiver for transmitting and receiving data over a USB link. A USB serial interface engine connects to the USB link and enables the conversion between the USB protocol and a serial interface protocol. A processor connects to the USB serial interface engine to control the operation of the engine. A memory interface includes a transmit data register for receiving data from a parallel data link and a receive register for receiving data to be transmitted over the parallel data link. The transmit data register and the receive register of the memory interface are located within a memory space of the processor. The memory interface is able to send and receive data between the transmit data register and the receive data register and an external processor over the parallel data link.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a USB connection between a USB host and a USB peripheral device containing a microcontroller;

FIG. 2 illustrates a connection between a USB host and a USB peripheral device containing a microcontroller through the USB bridge of the present disclosure;

FIG. 3 illustrates the interface connections of the parallel to USB bridge controller;

FIG. 4 is a block diagram illustrating the parallel to USB bridge controller;

FIG. 5 illustrates the manner in which the microcontroller writes to the memory space of the memory interface within the parallel to USB bridge controller;

FIG. 6a illustrates an overall block diagram of a mixed-signal integrated circuit in which a USB bridge controller may be implemented;

FIG. 6b illustrates a more detailed diagram of the integrated circuit of FIG. 5;

FIG. 6c is a block diagram of the USB Controller;

FIG. 7a is a flow diagram illustrating the receive operation of the parallel to USB bridge controller; and

FIG. 7b is a flow diagram illustrating the transmit operation of the parallel to USB bridge controller.

### DETAILED DESCRIPTION OF THE INVENTION

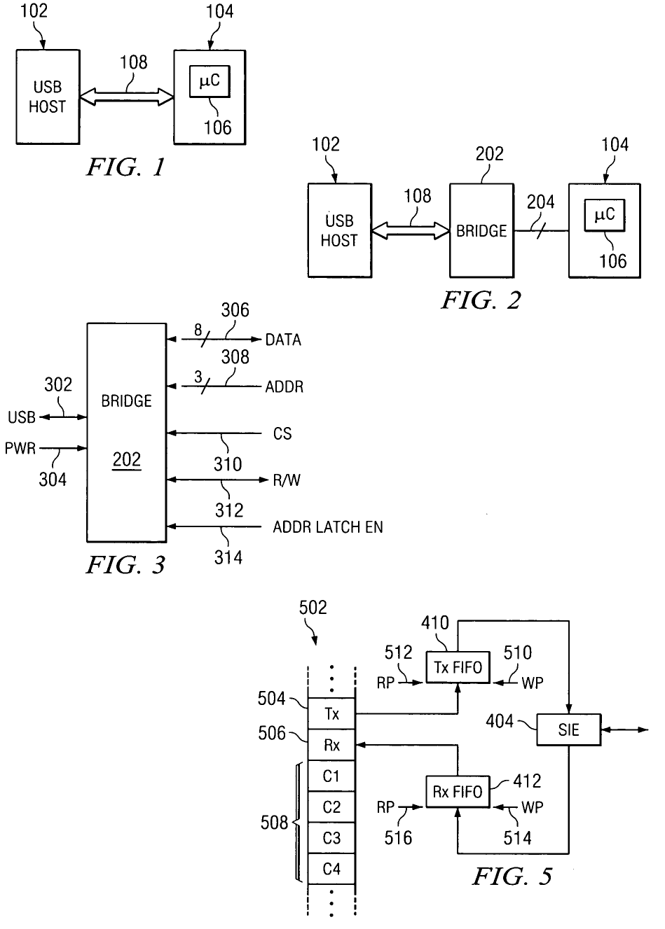

Referring now to the drawings, and more particularly to FIG. 1, there is illustrated a USB connection between a USB host 102 and a USB peripheral device 104 including a microcontroller 106. The USB peripheral device 104 interconnects with the USB host 102 over a USB connection 108. In this configuration, the microcontroller 106 within the USB peripheral device 104 is responsible for establishing the USB connection 108 with the USB host 102. Thus, the microcontroller 106 must configure data to be transmitted in the USB format for transmission over the USB connection 108. This requires a great deal of memory and coding resources within the microcontroller 106 of the USB peripheral device 104. Some manner for simplifying the operations of the microcontroller 106 within a USB peripheral device 104 would be greatly desirable.

Referring now to FIG. 2, there is illustrated the embodiment of the present disclosure wherein the USB host 102 and the USB peripheral device 104 including the microcontroller 106, are interconnected by a parallel to USB bridge controller 202. The parallel to USB bridge controller 202 provides a USB connection 108 between the USB host 102 and the bridge controller 202. The bridge controller 202 also provides a parallel bus connection 204 between the USB peripheral device 104 including microcontroller 106 and the bridge controller 202. Thus, the microcontroller 106 provides its normal parallel output to parallel connection 204. When this is received at the USB bridge 202, this parallel data is converted to USB data for transmission over the USB connection 108 to the USB host 102 in a manner which will be more fully described herein in a moment.

Referring now to FIG. 3, there is more fully illustrated the interface of the bridge controller 202 on both the USB side and the parallel bus side. The interface for the USB side of the connection includes the USB inputs 302 including the D+ and D− connections 303 and a power connection 304 providing power to the bridge controller 202. The parallel bus side of the interface of the bridge controller 202 includes an 8-bit parallel data bus 306 for providing parallel data between the bridge controller 202 and the microcontroller 106, a 3-bit parallel address bus 308 for indicating addresses at which data within the memory of the bridge controller 202 is to be accessed. A CS (chip select) line 310 for selecting the bridge controller 202 for operation. A read/write line 312 for indicating the performance of a Read or Write operation to the bridge controller 202 and an address latch enable 314 for enabling the data to be written to or read from the bridge controller 202. The mode “0” and mode “1” pins 316 are used to select the parallel bus interface mode for the bridge controller 202. These mode pins 316 may be used to select both non-multiplexed and multiplexed formats for Intel® formats and Motorola® formats. These formats are industry standard memory interface formats. The interrupt pin 318 is used to signal an interrupt request from the bridge controller 202. The data strobe 320 is used to indicate data available to be read.

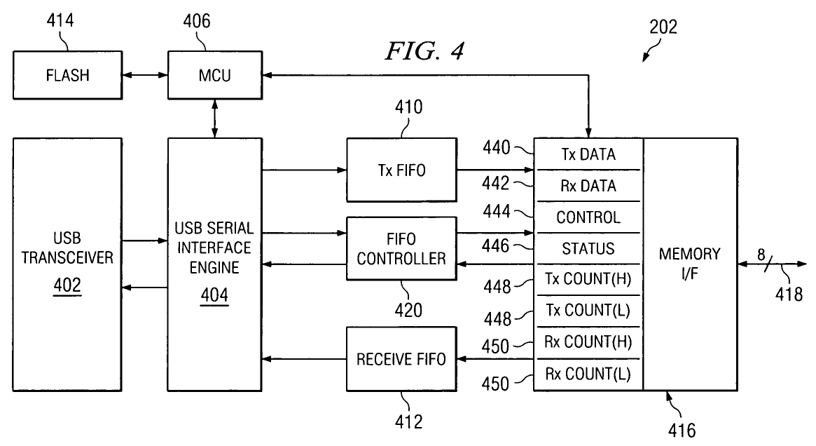

Referring now to FIG. 4, there is illustrated a block diagram of the parallel to USB bridge controller 202 of the present disclosure. The bridge controller 202 interfaces with the USB connection 108 through the USB transceiver 402. The USB transceiver 402 provides interconnection with either a USB 1.1 or USB 2.0 interface. USB transceiver 402 receives data from or provides data to the USB serial interface engine 404. The data is either being transmitted from the USB side to the parallel side or from the parallel side to the USB side, depending upon its direction. The USB transceiver 402 includes on-chip matching and pull-up resistors. The pull-up resistors can be enabled/disabled in software, and will appear on the D+ or D− pins according to the software selected speed setting for the transceiver, either full or low speed. The serial interface engine (SIE) 404 performs all low level USB protocol tasks, interrupting the MCU 406 when data has been successfully transmitted or received.

The serial interface engine 404 consists of a USB 2.0 controller, USB protocol engine interface logic and FIFO interface logic. The serial interface engine 404 routes control transactions to/from Endpoint 0 memory in the serial protocol engine (SPE) and routes data to/from the FIFOs on bulk and isochronous transfers. The SIE 404 can be configured to generate an IRQ used to reset the periodic “Transmit Now” timer whenever an intermediate transmit is forced by the MCU 406 via the FIFO controller 405. The Transmit Now signal is transmitted from the MCU 406 to the SIE 404. When transmitting data, the SIE 404 will interrupt the MCU 406 when a complete data packet has been transmitted and the appropriate hand shake signal has been received. The SIE 404 will not interrupt the MCU 406 when corrupted data packets are received.

Connected with the USB serial interface 404 is a Microcontroller Unit (MCU) 406. The MCU 406 acts as the serial protocol engine (SPE) and is responsible for USB enumeration, SIE configuration and responding to all USB control actions initiated by the USB host 102. In a preferred embodiment, the MCU 406 is comprised of an 8051 core running firmware and memory for Endpoint 0 (control end point). Endpoint 0 is mapped to the RAM space of the 8051. The SPE does not have direct access to the bulk/ISOC endpoints (FIFOs). The 8051 core includes 256 bytes of RAM, timers 0 and 1 and a low frequency oscillator used during low power suspend states to facilitate a remote wake-up function. The Serial Protocol Engine also maintains a timer to periodically generate a “Transmit Now” signal used to ensure periodic flushing of data in the transmit FIFO 410 (and host controller data buffers). This timer is reset automatically on each “Transmit Now” event and on receiving an IRQ from the SIE 404 signaling a data transmission (bulk or isochronous packet sent—control transactions do not reset the timer.)

In a disclosed embodiment, the MCU 406 comprises the 8051 processing core provided by Silicon Laboratories, Inc. The MCU 406 provides for processing functionalities within the parallel to USB bridge controller 202. The MCU 406 has no FIFO access. All data comes from the SIE 404 under the FIFO controller 420. Since the data goes from the SIE 404 directly to the FIFOs without going through the MCU 406, the data throughput is increased without additional processing power. Since the MCU 406 is located within the bridge controller 202, various tests may be designed and operated entirely within the bridge controller 202 without requiring external processing or instructions from an external microcontroller 106.

Associated with the MCU 406 is an integrated flash memory 414 that is fabricated on-chip with the MCU 406. The flash memory 414 enables the MCU 406 and the bridge controller 202 to be field programmable by a user. In one example, the FLASH memory 414 is used to convert the bridge controller 202 from operating according to the USB 1.1 protocol to the USB 2.0 protocol or vice verse. Additionally, various tests to be run by the MCU 406 within the bridge controller 202 may be added or deleted via the flash memory 414.

The parallel to USB bridge controller 202 additionally includes a transmit FIFO (first in, first out) buffer 410 and a receive FIFO buffer 412. The transmit FIFO 410 and receive FIFO 412 are connected between the USB serial interface engine 404 and the memory interface 416. The receive FIFO 412 receives data that has been converted from the USB format by the USB serial interface engine 404 and MCU 406 that is to be transmitted out of the bridge controller 202 over the parallel bus 418. Likewise, the transmit FIFO 410 receives data received over the parallel interface from an external USB peripheral device 104 (FIG. 2) and forwards the data from the transmit FIFO 410 to the USB serial engine 404 to be converted into USB format for transmission over the USB interface 108.

The FIFO controller 420 is connected between the transmit and receive FIFOs and between the SIE 404 and memory interface 416. The FIFO controller 420 handles automatic address pointer manipulation for the FIFOs 410, 412 as data is added and removed from the FIFOs 410, 412. The FIFO controller 420 also sends/receives FIFO status information to/from the serial interface engine 404.

The memory interface 416 is a standard memory interface for interfacing the bridge controller 202 to a standard 8-bit parallel bus 418. Via the standard memory interface 416, an external USB peripheral device 104 containing a microcontroller 106 may communicate with the bridge controller 202. The microcontroller 106 in the USB peripheral device 104 already contains programming enabling it to communicate with the standard memory interface 416. Thus, use of the standard memory interface 416 enables the external microcontroller 106 to communicate with the bridge controller 202 without any additional programming being required within the microcontroller 106, as the memory interface allows a block of external memory to be mapped into its address space. The memory interface 416 implements an 8-bit parallel bus interface in data/address multiplexed or non-multiplexed mode in either Intel® or Motorola® bus formats. Access to the FIFOs 410, 412 for data reads/writes as well as status and control is implemented through 8-byte wide registers contained within the memory interface 416. The memory interface 416 includes transmit 440 and receive 442 registers for enabling the transmission of data through the parallel to USB bridge controller 202 as well as control registers 444 for controlling the operation of the bridge controller 202, status registers 446 for indicating FIFO status and count registers 448 for indicating the number of bytes in a FIFO. These registers 440, 442, 444, 446 and 448 are snapped directly into the address space of microcontroller 106. This will be more fully described herein below with respect to FIG. 5.

The memory interface 416 reads byte wide data from the receive FIFO 412 via the receive data register 442. After a Read, a next available byte in the receive FIFO is mapped into the receive data register 442. The memory interface 416 uses the transmit data register 440 to write data into the transmit FIFO 410. A Write to the transmit data register 440 adds the data to the next available space in the transmit FIFO 410.

The control register 444 includes information defining operations of the bridge controller 202 in the following manner. Bit positions 1 and 2 define the transmit interrupt configurations. For “00,” the transmit interrupts are disabled. For “01,” the transmit interrupts are generated on transmit FIFO 410 not full. For “10,” the transmit interrupt is generated when the transmit FIFO 410 is half full, and for “11,” the transmit interrupt is generated when the transmit FIFO 410 is one-fourth full. Bit positions 3 and 4 define the receive interrupt configuration. For “00,” the receive interrupts are disabled. For “01,” the receive interrupt is generated on receive FIFO 412 not empty. For “10,” the receive interrupt is generated on receive FIFO 412 half full, and for “11,” the receive interrupt is generated when the receive FIFO 412 is three-fourths full. Bit positions 5 and 6 have not been defined. Bit position 7 is the transmit immediately bit. Setting this bit causes all data in the transmit FIFO to be transmitted across the USB bus regardless of data payload size. The bit is cleared by the hardware when the transmit FIFO 410 is empty. The 8th bit of the control register 444 is the ENDIANNES bit. When this bit is set to “0,” the 16-bit FIFO count registers 448, 450 described below are organized with the least significant bit at the lowest address. If this bit is set to “1,” the 16-bit FIFO count registers 448, 450 are organized with the most significant bit at the lowest address.

The status register 446 operates in the following manner. Bits 0-5 are presently undefined. Bit 6 is used to indicate when a part is configured and ready for operation. Bit 7 is the Transmit Interrupt Pending Flag. The Transmit Interrupt Pending Flag is set by hardware whenever the number of bytes in the transmit FIFO 410 reaches the configured threshold. The Transmit Interrupt Pending Flag is cleared by software writing a zero to this bit. If TX Interrupts are enabled, an IRQ signal is generated on the INT pin 318 whenever this bit is set (by either hardware or software). Bit 8 is the Receive Interrupt Pending Flag. The Receive Interrupt Pending Flag is set by hardware whenever the number of bytes in the receive FIFO 412 reaches the configured threshold. The Receive Interrupt Pending Flag is cleared by software writing a zero to this bit. If RX Interrupts are enabled, an IRQ signal is generated on the INT pin 318 whenever this bit is set (by either hardware or software). The transmit count registers 448 indicate the number of bytes in the transmit FIFO 410 to be transmitted. The receive count registers 450 indicate the number of bytes available to be read in the receive FIFO 412.

The bridge controller 202 provides bi-directional data transfer between a microcontroller based peripheral device 104 and a host PC 102 via the USB connection 108. The bridge controller performs parallel to serial conversion on data placed in the transmit FIFO 410 and transmits the data to the host PC 102 via the USB connection 108. Serial data received from the host PC 102 via the USB connection 108 is converted to 8-bit parallel data and stored in the receive FIFO 412. The bridge controller 202 receive and transmit FIFOs, as well as FIFO control and status are accessed by the peripheral's microcontroller via an 8-bit parallel bus and the memory interface 416. The memory interface 416 may be configured to operate in either a multiplexed/non-multiplexed configuration and in either an Intel® or Motorola® bus format.

FIFO status can be monitored by either polling a status register 440 or by configuring the bridge controller 202 to generate interrupt requests on various FIFO status events. Transmission of data from the transmit FIFO 410 is initiated by either setting a bit in a control register 444 to initiate a transfer immediately or whenever the number of bytes in the transmit FIFO 410 reaches a predetermined threshold (determined by the USB transfer type in use). Transmission of data is also initialized by the MCU 406 sending a Transmit Now signal to the SIE 404 after a predetermined period of time has passed since a last packet was sent. Rights to the receive FIFO 412 by the USB serial interface engine 404 are prevented when sufficient room to store incoming data is not available. The bridge controller 202 may be configured to support either bulk or isochronous USB transfer types.

Referring now to FIG. 5, there is more fully illustrated the manner in which the external microcontroller 106 associated with a USB peripheral device 104 may write data to the transmit data register 440 in the memory interface 416 or read data from the receive data register 442 in the memory interface 416. The transmit data register 440 and receive data register 442 in the memory interface 416 are configured such that the registers reside within the memory space of the MCU 406 associated with the bridge controller 202. Since the transmit data and receive data registers 440, 442 are located within the memory space of the MCU 406, data may be written directly to or read directly from this memory space by the external MCU 106 through the parallel bus 108. This enables the transfer of data between the microcontroller 106 and the memory space 502 of the microcontroller 406 that is associated with the memory interface 408. A first location 504 within the memory space 502 is used for containing transmitted data that is being transmitted from the external microcontroller 106 to the USB host 102 over the USB connection 108. This location 504 within the memory space 106 is where data transmitted from the external microcontroller 106 is always placed by the microcontroller 106 and corresponds to the transmit data register 440. As described previously, since the microcontroller 106 is already programmed to communicate with the memory interface 416, no additional configuration of the external microcontroller 106 is necessary since it merely addresses the location 504 within the memory space of the MCU 406 of the bridge controller 202. After the transmit data has been placed within the memory space location 504, the transmit data may be written into the transmit FIFO 410. The location that the transmit data is stored within the transmit FIFO 410 depends upon the location presently being pointed to by a write pointer 510. Data is transmitted out of the transmit FIFO 410 to the USB serial interface engine 404. The data is read from the transmit FIFO 410 to the SIE 414 with the data byte first being read indicated by a read pointer 512. Note that the transmit register 440 may be integrated into the transmit FIFO 410 so that the Write pointer maps the address to the FIFO 410.

Data received over the USB connection 108 is provided from the serial interface engine 404 to the receive FIFO 412. Similar to the transmit FIFO 410, the location into which the received data is written in the receive FIFO 412 is indicated by the Write pointer 514. Data to be read by the external microcontroller 106 is provided to a receive location 506 within the memory space 502 of the bridge controller 202 to MCU 406. This receive location 506 corresponds to the receive data register 442 of the memory interface 416. The data in the receive buffer 412 to be placed within the receive location 506 is indicated by the Read pointer 516. In addition to the location 504 for transmit data and the location 506 for received data, the memory space associated with the memory interface 416 also includes a number of locations 508 associated with the control register, status register and transmit and receive count registers. In this manner, the operation of the bridge controller 202 may be controlled by the MCU 406 and the register data in locations 508.

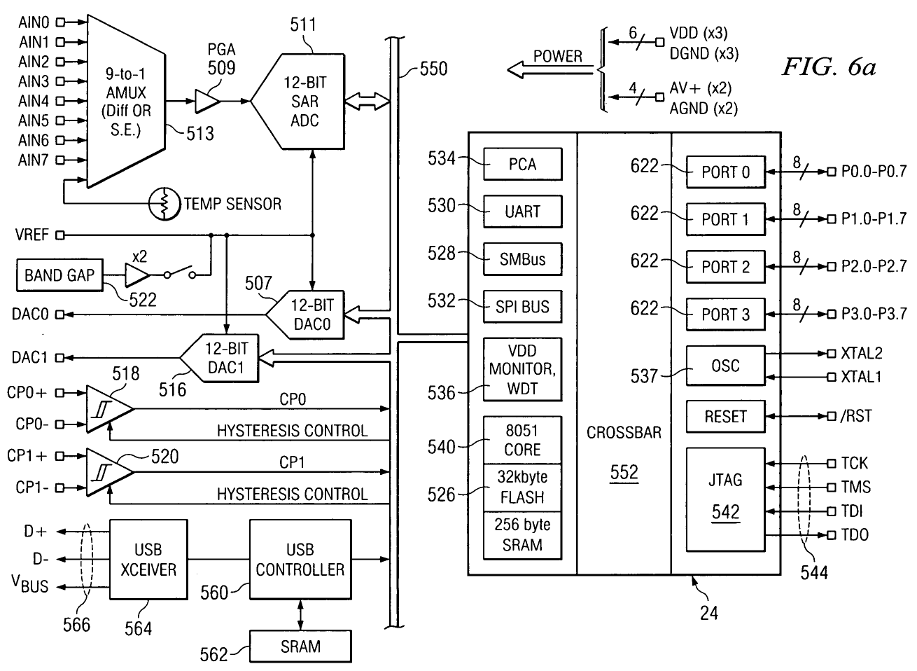

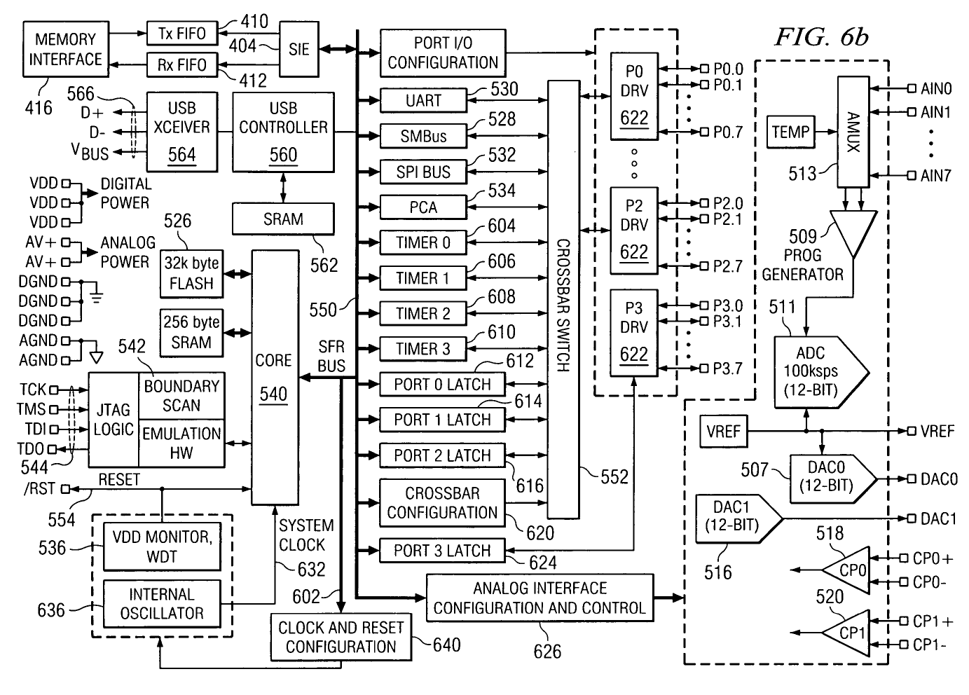

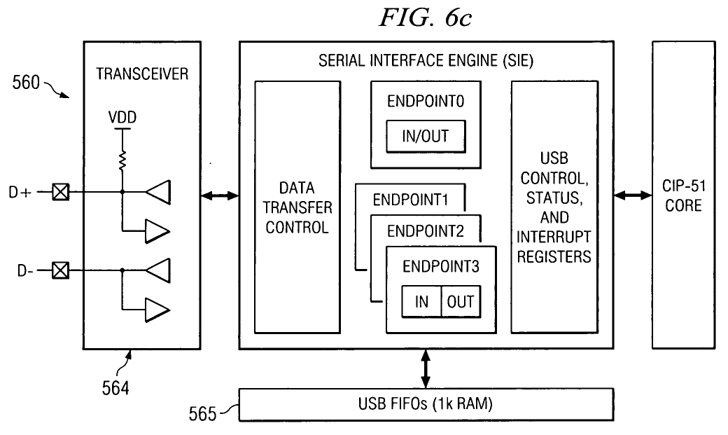

The following disclosure in FIGS. 6a and 6b includes a number of components which may not be necessary to the bridge controller 202. These components include the UART 530, crossbar 552, parallel I/O ports, ADC 510, PGA 509, AMUX 513, DACs 507 and 516, comparators 518 and 520, PCA 534, I2C/SMBUS, and the SPI bus. Referring now to FIG. 6a, there is illustrated one example of an integrated circuit into which the parallel to USB bridge controller 202 may be implemented that is comprised of a fully integrated mixed-signal System on a Chip with a true 12-bit multi-channel ADC 511 with a programmable gain pre-amplifier 509, two 12-bit DACs 507 and 516, two voltage comparators 518 and 520, a voltage reference 22, and an 8051-compatible microcontroller core 524 with 32 kbytes of FLASH memory 526. There is also provided an I2C/SMBUS 528, a UART 530, and an SPI 532 serial interface 540 implemented in hardware (not “bit-banged” in user software) as well as a Programmable Counter/Timer Array (PCA) 534 with five capture/compare modules. There are also 32 general purpose digital Port I/Os. The analog side further includes a multiplexer 513 as operable to interface eight analog inputs to the programmable amplifier 512 and to the ADC 510. This structure is basically found in Part Number C8051F320 manufactured by Silicon Laboratories, Inc.

With an on-board V_{DD} monitor 536, WDT, and clock oscillator 537, the integrated circuit is a stand-alone System on a Chip. The MCU effectively configures and manages the analog and digital peripherals. The FLASH memory 526 can be reprogrammed in-circuit, providing non-volatile data storage, and also allowing field upgrades of the 8051 firmware. The MCU can also individually shut down any or all of the peripherals to conserve power.

A C2 interface 542 allows the user to interface with the integrated circuit through a 2-wire interface. The C2 interface is an on-chip 2-wire debug interface used by Silicon Labs to allow flash programming, boundary scan functions, and in-system debugging with the production part installed in the end application. The C2 interface uses a clock signal (C2CK) and a bi-directional C2 data signal (C2D) to transfer information between the device and a host system. This uses the C2 protocol which is described in the C2 interface specification which is incorporated herein by reference. The C2 protocol allows the C2 pins to be shared with user functions so that in-system debugging, flash programming, and boundary scan functions may be performed. This is possible because C2 communications typically perform when the device is in the halt state, where all on-chip peripherals and user software are stalled. In this halted state, the C2 interface can safely borrow the C2CK (/RST) and C2D (P3.0) pins. In most applications, external resistors are required to isolate C2 interface traffic from the user application. On-board debug support allows non-intrusive (uses no on-chip resources), full speed, in-circuit debug using the production integrated circuit installed in the final application. This debug system supports inspection and modification of memory and registers, setting breakpoints, watch points, single stepping, run and halt commands. All analog and digital peripherals are fully functional when debugging.

The microcontroller 540 is fully compatible with the MCS-5™ instruction set. Standard 803x/805x assemblers and compilers can be used to develop software. The core has all the peripherals included with a standard 8052, including three 16-bit counter/timers, a full-duplex UART, 256 bytes of internal RAM, 128 byte Special Function Register (SFR) address space, and four byte-wide I/O Ports. A Universal Serial Bus (USB) interface interfaces with memory 562 and a USB transceiver 564. The transceiver 564 will interface with dedicated pins 566 to receive/transmit serial data.

Referring further to FIG. 6a, the microcontroller core 541 is interfaced through an internal BUS 550 to the various input/output blocks. A cross-bar switch 552 provides an interface between the UART 530, SPI BUS 532, etc., and the digital I/O output. This is a configurable interface.

The core 540 employs a pipelined architecture that greatly increases its instruction throughput over the standard 8051 architecture. In a standard 8051, all instructions except for MUL and DIV take 12 or 24 system clock cycles to execute with a maximum system clock of 12 MHz. By contrast, the core 540 executes seventy percent (70%) of its instructions in one or two system clock cycles, with only four instructions taking more than four system clock cycles. The core 540 has a total of 509 instructions. The number of instructions versus the system clock cycles to execute them is as follows:

| | Instructions | | | | | | | | |
|---|---|---|---|---|---|---|---|---|---|
| | 26 | 50 | 5 | 14 | 7 | 3 | 1 | 2 | 1 |
| Clocks to Execute | 1 | 2 | ⅔ | 3 | ¾ | 4 | ⅘ | 5 | 8 |

With the core 540's maximum system clock at 20 MHz, it has a peak throughput of 20MIPS.

As an overview to the system of FIG. 6a, the cross-bar switch 552 can be configured to interface any of the ports of the I/O side thereof to any of the functional blocks 528, 530, 532, 534 or 536 which provide interface between the cross-bar switch 552 and the core 540. Further, the cross-bar switch can also interface through these functional blocks 528-536 directly to the BUS 550.

Referring now to FIG. 6b, there is illustrated a more detailed block diagram of the integrated circuit in which the USB to parallel bridge controller 202 could be implemented. In this embodiment, it can be seen that a cross-bar switch 552 actually interfaces to a system BUS 602 through the BUS 550. The BUS 550 is operable to allow core 540 (corresponding to MCU 406) to interface with the various functional blocks 528-534 in addition to a plurality of timers 604, 606, 608 and 610, in addition to three latches 612, 614 and 616. The cross-bar switch 552 is configured with a configuration block 620 that is configured by the core 540. The other side of the cross-bar switch 552, the I/O side, is interfaced with various port drivers 622, which is controlled by a port latch 624 that interfaces with the BUS 550. In addition, the core 540 is operable to configure the analog side with an analog interface configuration in control block 626.

The core 540 is controlled by a clock on a line 632. The internal oscillator circuit 636 is a precision temperature compensated oscillator, as will be described herein below. The core 540 is also controlled by a reset input on a reset line 554. The reset signal is also generated by the watchdog timer (WDT) circuit 536, the clock and reset circuitry all controlled by clock and reset configuration block 640, which is controlled by the core 540. Therefore, it can be seen that the user can configure the system to operate with an external crystal oscillator or an internal precision non-crystal non-stabilized oscillator that is basically “free-running.” This oscillator 636 generates the timing for both the core 540 and for the UART 530 timing and is stable over temperature.

The description of the precision oscillator 636 is described in U.S. patent application Ser. No. 10/244,728, filed Sep. 16, 2002 and entitled “CLOCK RECOVERY METHOD FOR BURSTY COMMUNICATIONS” (Atty. Docket No. CYGL-26,068), which is incorporated by reference in its entirety.

The processor housing portion of each of the modules noted herein utilizes a processor that can interface with an asynchronous data protocol such as a USB data protocol without requiring a crystal. This is due to the fact that the processor has disposed thereon a precision oscillator that can track a frequency close enough that it does not require a crystal time base, within +/−2%. By not requiring a crystal time base, a much more compact configuration can be provided. The transmit FIFO 410, receive FIFO 412 and control register 408 are interconnected with the USB controller 560 and the processing core 540 via the bus 550. The USB controller 560 includes the USB serial interface engine enabling the conversion between USB data and parallel data available on opposite sides of the bridge controller 202.

Referring now to FIG. 6c, the Universal Serial Bus Controller 560 is a USB 2.0 compliant Full or Low Speed function with integrated transceiver 564 and endpoint FIFO RAM. A total of eight endpoint pipes are available: a bi-directional control endpoint (Endpoint0) and three pairs of IN/OUT endpoints (Endpoints 1-3 IN/OUT).

A 1 k block of XRAM 565 is used as dedicated USB FIFO space. This FIFO space is distributed among Endpoints0-3; Endpoint1-3 FIFO slots can be configured as IN, OUT, or both IN and OUT (split mode). The maximum FIFO size is 512 bytes (Endpoint3).

USB controller 560 can be operated as a Full or Low Speed function. On-chip 4× Clock Multiplier and clock recovery circuitry allow both Full and Low Speed options to be implemented with the on-chip precision oscillator as the USB clock source. An external oscillator source can also be used with the 4× Clock Multiplier to generate the USB clock. The CPU clock source is independent of the USB clock.

The USB Transceiver 564 is USB 2.0 compliant, and includes on-chip matching and pull-up resistors. The pull-up resistors can be enabled/disabled in software, and will appear on the D+ or D− pin according to the software-selected speed setting (Full or Low Speed).

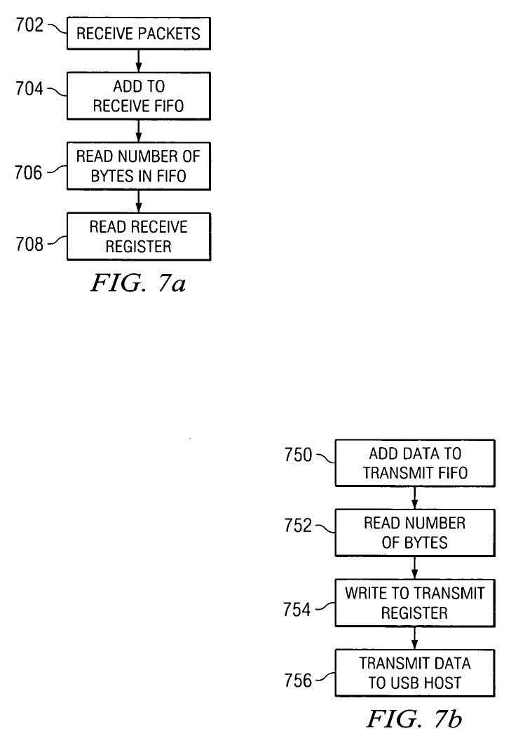

Referring now to FIGS. 7a and 7b, there are illustrated flow diagrams describing the transmission and reception of data through the parallel to USB bridge controller 202. Referring now to FIG. 7a, as data packets are received from the USB host 102 by the SIE at step 702, the data payload of each packet is added at step 704 to the receive FIFO 412 as long as there is sufficient room to buffer the entire data payload. If the entire external data payload cannot be buffered, the packet is rejected (NAK sent to host). The external microcontroller 106 removes data from the receive FIFO 412 by first reading the number of bytes currently in the receive FIFO 412 from the receive count registers 450 at step 706 and repeatedly reading at step 708 to the receive data register 442 from the receive FIFO 412 up to as many times as there are bytes of data currently in the receive FIFO 412. The receive count 450 is continuously updated as data is added and removed from the receive FIFO 412. The FIFO Controller 420 will generate an Interrupt Request Signal (IRQ) on the INT pin 418 whenever the number of bytes in the receive FIFO 412 reaches a threshold as configured in the FIFO Control register 444.

Referring now to FIG. 7b, data is sent from the microcontroller 106 to the USB host 102 by adding it to the transmit FIFO 410 at step 750. Data is added to the transmit FIFO 410 by first reading at step 752 the number of bytes available from the transmit count registers 448 and repeatedly writing at step 754 to the transmit data register 440 from the microcontroller 106 with new data up to as many times as there are bytes of space available. The transmit count 448 is continuously updated as data is added and removed from the transmit FIFO 410. The FIFO Controller 420 will generate an Interrupt Request Signal (IRQ) on the INT pin 418 whenever the amount of space (number of bytes) in the transmit FIFO 410 reaches a threshold as configured in the FIFO control register 444.

Transmission of data from the transmit FIFO 410 to the USB host 102 is initiated at step 756 immediately on any of three conditions: 1) the TXI flag in the FIFO control register 420 is set by the microcontroller 106; 2) the number of bytes in the transmit FIFO 410 reaches a count of PACKETSIZE (configured by the MCU 406); and 3) on a period “Transmit Now” signal received from the USB Protocol Engine. If the transmission event is initiated by setting the TXI flag or on receiving the “Transmit Now” signal, all of the data currently in the transmit FIFO 410 is sent to the USB host 102 by the SIE 404. If the number of bytes sent equals an exact integer multiple of PACKETSIZE, a transmission of a O-byte packet follows to terminate the transaction. (A 0-byte packet is also sent anytime TXI or “Transmit Now” events occur while the transmit FIFO 410 is empty).

If the TXI or “Transmit Now” signals are not received, the FIFO Controller 420 waits for PACKETSIZE number of bytes to accumulate in the transmit FIFO 410, and signals the SIE 404 to send PACKETSIZE number of bytes to the USB host 102 when this occurs. Once the data is sent, the FIFO Controller 420 waits for another PACKETSIZE number of bytes to accumulate in the transmit FIFO 410. This ensures additional IN Tokens from the USB host 102 to maximize the number of packets available per frame.

Although the preferred embodiment has been described in detail, it should be understood that various changes, substitutions and alterations can be made therein without departing from the scope of the invention as defined by the appended claims.

What is claimed is:

1. A parallel to serial bridge controller, comprising:
a USB transceiver for transmitting and receiving on a USB link;
a USB serial interface engine connected to the USB link for converting between USB protocol and serial interface protocol;
a processor connected to the USB serial interface engine for controlling the operation of the USB serial interface engine;
a memory interface including a transmit data register for receiving data from a parallel data link and a receive data register for receiving data to be transmitted over the parallel data link, the transmit data register and the receive data register of the memory interface being located within a memory space of the processor, said memory interface able to send and receive data between the transmit data register and the receive data register and an external processor over the parallel data link.

2. The parallel to serial bridge controller of claim 1, further including:
a first FIFO buffer for temporarily storing data from the USB serial interface engine before sending the data to receive data register of the memory interface; and
a second FIFO buffer for temporarily storing data from the transmit data register of the memory interface before sending to the USB serial interface engine.

3. The parallel to serial bridge controller of claim 2, wherein the memory interface further includes at least one status register for storing data relating to the status of the first FIFO buffer and the second FIFO buffer.

4. The parallel to serial bridge controller of claim 2, wherein the memory interface further includes:
at least one first count register for storing data relating to available space of the first FIFO buffer;
at least one second count register for storing data relating to available space of the second FIFO buffer.

5. The parallel to serial bridge controller of claim 2, wherein the first FIFO buffer includes:
a write pointer for pointing to a memory location in the first FIFO buffer to store data from the USB serial interface engine; and
a read pointer for pointing to a memory location in the first FIFO buffer to store data to send to the receive data register in the memory interface.

6. The parallel to serial bridge controller of claim 2, wherein the second FIFO buffer includes:
a write pointer for pointing to a memory location in the second FIFO buffer to store data from the transmit data register in the memory interface; and
a read pointer for pointing to a memory location in the second FIFO buffer to store data to send to the USB serial interface engine.

7. The parallel to serial bridge controller of claim 1, further including a flash memory connected to the processor enabling user programable control of the operation of the parallel to serial bridge controller.

8. The parallel to serial bridge controller of claim 1, wherein the memory interface further includes at least one control register for storing control data for controlling operation of the parallel to serial bridge controller.

9. A parallel to serial bridge controller, comprising:
a USB transceiver for transmitting and receiving on a USB link;
a USB serial interface engine connected to the USB link for converting between USB protocol and serial interface protocol;
a processor connected to the USB serial interface engine for controlling the operation of the USB serial interface engine;
a flash memory connected to the processor enabling user programable control of the operation of the parallel to serial bridge controller;
a memory interface including a transmit data register for receiving data from a parallel data link and a receive data register for receiving data to be transmitted over the parallel data link, the transmit data register and the receive data register of the memory interface being located within a memory space of the processor, said memory interface able to send and receive data between the transmit data register and the receive data register and an external processor over the parallel data link;
a first FIFO buffer for temporarily storing data from the USB serial interface engine before sending the data to receive data register of the memory interface; and
a second FIFO buffer for temporarily storing data from the transmit data register of the memory interface before sending to the USB serial interface engine.

10. The parallel to serial bridge controller of claim 9, wherein the memory interface further includes at least one status register for storing data relating to the status of the first FIFO buffer and the second FIFO buffer.

11. The parallel to serial bridge controller of claim 9, wherein the memory interface further includes:
at least one first count register for storing data relating to available space of the first FIFO buffer;
at least one second count register for storing data relating to available space of the second FIFO buffer.

12. The parallel to serial bridge controller of claim 9, wherein the first FIFO buffer includes:
a write pointer for pointing to a memory location in the first FIFO buffer to store data from the USB serial interface engine; and
a read pointer for pointing to a memory location in the first FIFO buffer to store data to send to the receive data register in the memory interface.

13. The parallel to serial bridge controller of claim 9, wherein the second FIFO buffer includes:
a write pointer for pointing to a memory location in the second FIFO buffer to store data from the transmit data register in the memory interface; and
a read pointer for pointing to a memory location in the second FIFO buffer to store data to send to the USB serial interface engine.

14. The parallel to serial bridge controller of claim 9, wherein the memory interface further includes at least one control register for storing control data for controlling operation of the parallel to serial bridge controller.
